(19) United States
(12) Patent Application Publication
(10) Pub. No.: US 2026/0161673 A1
(43) Pub. Date: Jun. 11, 2026

(54) GROUNDING GENERATIVE QUESTIONS FOR PREVENTING HALLUCINATIONS FROM A LARGE LANGUAGE MODEL

(71) Applicant: INTERNATIONAL BUSINESS MACHINES CORPORATION, ARMONK, NY (US)

(72) Inventors: Hosam Aly, Kanata (CA); Christine Kwan, Toronto (CA); Roman Rezinkin, Richmond Hill (CA); OLEH ZHYHINAS, Toronto (CA)

(21) Appl. No.: 18/975,320

(22) Filed: Dec. 10, 2024

(51) Int. Cl. G06F 16/332; G06F 16/21; G06F 40/205

(52) U.S. Cl. CPC G06F 16/332; G06F 16/211; G06F 40/205

(57) ABSTRACT

A computer-implemented method for automatically grounding generative questions generated from a large language model (LLM) to prevent hallucinations from the LLM. The computer-implemented may include retrieving a database schema by extracting metadata associated with at least one database. The computer-implemented may further include based on the extracted metadata, automatically generating, using a generative artificial intelligence (AI) algorithm, a simplified database schema. The computer-implemented may also include automatically generating, using the generative AI algorithm, a custom prompt based on the simplified database schema. The computer-implemented may further include automatically generating, using the LLM, the one or more different types of questions based on the generated custom prompt. The computer-implemented may also include automatically validating the generated one or more different types of questions using an SQL parser to parse the SQL representation of the generated question.

### BACKGROUND

The present invention relates generally to the field of computing, and more specifically, to automatically grounding generative questions generated from a large language model (LLM), including techniques for automatically generating and validating the generative questions to ensure relevancy, accuracy, and solvability of the generative questions by the LLM based on a database schema.

Generally, a large language model (LLM) includes a computational model that uses deep learning to perform natural language processing (NLP) tasks. LLMs are typically trained on vast amounts of text data to learn statistical relationships. Specifically, LLMs are a class of foundation models, which are trained on enormous amounts of data to provide the foundational capabilities needed to drive multiple use cases and applications, as well as resolve a multitude of tasks. Furthermore, LLMs consist of multiple layers of neural networks, each with parameters that can be fine-tuned during training, which are enhanced further by a numerous layer known as the attention mechanism, which dials in on specific parts of data sets. In turn, LLMs can generate and translate text, summarize and answer questions, classify text, and more. LLMs can also mimic human speech patterns and combine information in different styles and tones.

### SUMMARY

A computer-implemented method for automatically grounding generative questions generated from a large language model (LLM) to prevent hallucinations from the LLM is provided. The computer-implemented may include retrieving a database schema by extracting metadata associated with at least one database. The computer-implemented may further include based on the extracted metadata, automatically generating, using a generative artificial intelligence (AI) agent/algorithm, a simplified database schema comprising simplified database schema objects. The computer-implemented may also include automatically generating, using the generative AI agent/algorithm, a custom prompt based on the simplified database schema, wherein automatically generating the custom prompt further comprises generating an instruction set prompting the LLM to generate one or more different types of questions based on the simplified database schema. The computer-implemented may further include automatically generating, using the LLM, the one or more different types of questions based on the generated custom prompt, wherein generating the one or more different types of questions further comprises using the LLM to generate for each question a structured query language (SQL) representation of a generated question and an identification of a question type associated with the generated question. The computer-implemented may also include automatically validating the generated one or more different types of questions using an SQL parser to parse the SQL representation of the generated question, wherein using an SQL parser to parse the SQL representation of the generated question further comprises extracting columns from the simplified database schema matching the SQL representation.

A computer system for automatically grounding generative questions generated from a large language model (LLM) to prevent hallucinations from the LLM is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing operational steps. The operational steps may include retrieving a database schema by extracting metadata associated with at least one database. The operational steps may further include based on the extracted metadata, automatically generating, using a generative artificial intelligence (AI) agent/algorithm, a simplified database schema comprising simplified database schema objects. The operational steps may also include automatically generating, using the generative AI agent/algorithm, a custom prompt based on the simplified database schema, wherein automatically generating the custom prompt further comprises generating an instruction set prompting the LLM to generate one or more different types of questions based on the simplified database schema. The operational steps may further include automatically generating, using the LLM, the one or more different types of questions based on the generated custom prompt, wherein generating the one or more different types of questions further comprises using the LLM to generate for each question a structured query language (SQL) representation of a generated question and an identification of a question type associated with the generated question. The operational steps may also include automatically validating the generated one or more different types of questions using an SQL parser to parse the SQL representation of the generated question, wherein using an SQL parser to parse the SQL representation of the generated question further comprises extracting columns from the simplified database schema matching the SQL representation.

A computer program product for automatically grounding generative questions generated from a large language model (LLM) to prevent hallucinations from the LLM is provided. The computer program product may include one or more computer-readable storage devices and program instructions stored on at least one of the one or more tangible storage devices, the program instructions executable by a processor. The computer program product may include program instructions to retrieve a database schema by extracting metadata associated with at least one database. The computer program product may include program instructions to, based on the extracted metadata, automatically generate, using a generative artificial intelligence (AI) agent/algorithm, a simplified database schema comprising simplified database schema objects. The computer program product may include program instructions to automatically generate, using the generative AI agent/algorithm, a custom prompt based on the simplified database schema, wherein automatically generating the custom prompt further comprises generating an instruction set prompting the LLM to generate one or more different types of questions based on the simplified database schema. The computer program product may include program instructions to automatically generate, using the LLM, the one or more different types of questions based on the generated custom prompt, wherein generating the one or more different types of questions further comprises using the LLM to generate for each question a structured query language (SQL) representation of a generated question and an identification of a question type associated with the generated question. The computer program product may include program instructions to automatically validate the generated one or more different types of questions using an SQL parser to parse the SQL representation of the generated question, wherein using an SQL parser to parse the SQL representation of the generated question further comprises extracting columns from the simplified database schema matching the SQL representation.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is a block diagram of an operational flowchart for a program for automatically grounding generative questions generated from a large language model (LLM) to prevent hallucinations from the LLM according to one embodiment;

FIG. 3 is example output including generated questions from the LLM based on a program for automatically grounding generative questions generated from a large language model (LLM) to prevent hallucinations from the LLM according to one embodiment;

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically grounding generative questions generated from a large language model (LLM) to prevent hallucinations from the LLM. Specifically, the present invention may improve the technical field associated with LLMs by automatically generating and validating the generative questions from the LLM to ensure the relevancy, accuracy, and solvability of the generative questions by the LLM based on a database schema.

As previously described, a large language model (LLM) includes a computational model that uses deep learning to perform natural language processing (NLP) tasks. LLMs are typically trained on vast amounts of text data to learn statistical relationships and to provide the foundational capabilities needed to drive multiple use cases and applications. In turn, LLMs can generate and translate text, summarize and answer questions, classify text, and more. However, most large-language model (LLM) based applications face a challenge in ensuring that the LLM does not hallucinate, i.e. when the model generates a response that is false, nonsensical, or inconsistent with the input prompt, which may apply to various uses of the LLM.

Generally, grounding is the process of using large language models (LLMs) with information that is use-case specific, relevant, and not available as part of the LLM's trained knowledge. It is crucial for ensuring the quality, accuracy, and relevance of the generated output. While LLMs come with a vast amount of knowledge already, such knowledge may be typically limited and not necessarily tailored to specific use-cases. To obtain accurate and relevant output, LLMs must be provided with the necessary information. In other words, it becomes necessary to “ground” the models in the context of a specific use-case while ensuring that the LLM does not hallucinate. Depending on the complexity of the LLM use, solutions for protecting against hallucination may be complex, slow, and/or expensive. Furthermore, such solutions typically involve using other sources of data as well as other LLM calls to validate answers produced by the LLM. As such, it may be advantageous to protect against such LLM hallucinations by, among other things, providing a method, computer system, and computer program product for automatically grounding generative questions generated from a large language model (LLM) to prevent hallucinations from the LLM, including techniques for automatically generating and validating the generative questions to ensure the relevancy, accuracy, and solvability of the generative questions by the LLM based on a received database schema.

Specifically, the method, computer system, and computer program product may retrieve a database schema by extracting metadata associated with at least one database. Specifically, retrieving a database schema by extracting metadata associated with at least one database may have the technical effect of using metadata that describes text, columns, and other data from a database (rather than text itself) to generate questions.

The method, computer system, and computer program product may, based on the extracted metadata, automatically generate, using a generative artificial intelligence (AI) agent/algorithm, a simplified database schema comprising simplified database schema objects. Specifically, automatically generating, using a generative artificial intelligence (AI) agent/algorithm, a simplified database schema comprising simplified database schema objects may have the technical effect of having column information from the simplified database schema to help guide the LLM with identifying/understanding an industry type of a database schema and generating questions relevant to the database schema and the industry type.

The method, computer system, and computer program product may automatically generate, using the generative AI agent/algorithm, a custom prompt based on the simplified database schema, wherein automatically generating the custom prompt further comprises generating an instruction set prompting the LLM to generate one or more different types of questions based on the simplified database schema. Specifically, automatically generating, using the generative AI agent/algorithm, a custom prompt based on the simplified database schema, wherein automatically generating the custom prompt further comprises generating an instruction set prompting the LLM to generate one or more different types of questions based on the simplified database schema may have the technical effect of using the LLM to generate questions that are not selected from a library, whereby the questions are based on the description of the data via the metadata and not the data itself or semantic analysis of the data, and whereby questions are generated based on an overall data set and not just a part of it.

The method, computer system, and computer program product may automatically generate, using the LLM, the one or more different types of questions based on the generated custom prompt, wherein generating the one or more different types of questions further comprises using the LLM to generate for each question a structured query language (SQL) representation of a generated question and an identification of a question type associated with the generated question. Specifically, generating, using the LLM, the one or more different types of questions based on the generated custom prompt, wherein generating the one or more different types of questions further comprises using the LLM to generate for each question a structured query language (SQL) representation of a generated question and an identification of a question type associated with the generated question may again have the technical effect of using the LLM to generate questions that are not selected from a library, whereby the questions are based on the description of the data via the metadata and the data itself making the questions more related to the data, and whereby questions are generated based on an overall data set and not just a part of it.

The method, computer system, and computer program product may automatically validate the generated one or more different types of questions using an SQL parser to parse the SQL representation of the generated question, wherein using an SQL parser to parse the SQL representation of the generated question further comprises extracting columns from the simplified database schema matching the SQL representation. Specifically, automatically validate the generated one or more different types of questions using an SQL parser to parse the SQL representation of the generated question, wherein using an SQL parser to parse the SQL representation of the generated question further comprises extracting columns from the simplified database schema matching the SQL representation may have the technical effect of ensuring the relevancy, accuracy, and solvability of the generative questions by the LLM based on a database schema

The present invention may be a computer system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer program product and computer readable storage medium, as those terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to automatically generate a screen recorded video based on natural language text.

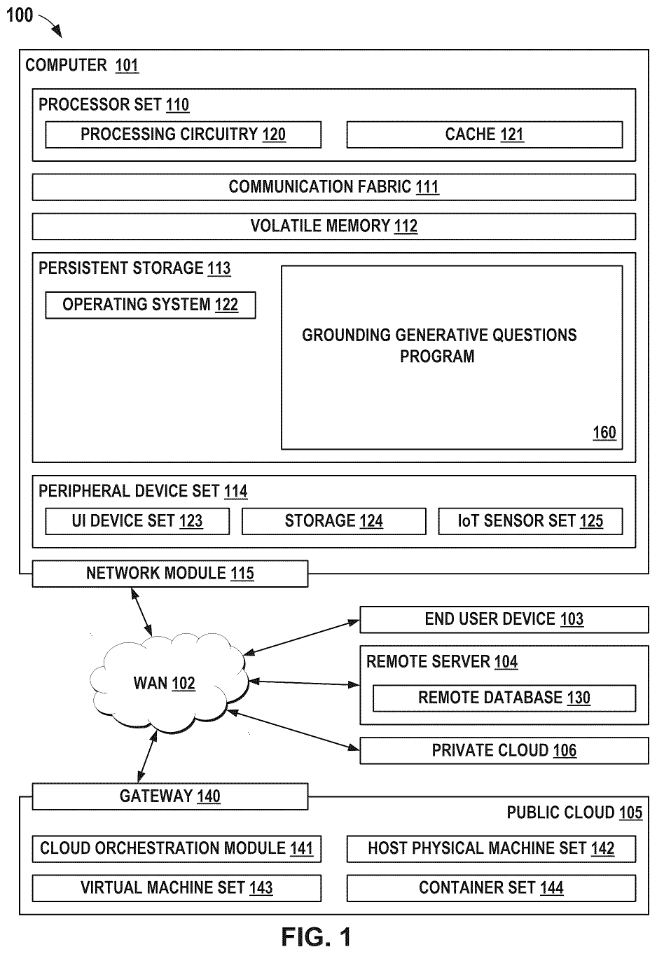

Referring to FIG. 1, an exemplary computing environment 100 is depicted, according to at least one embodiment. Computing environment 100 contains an example of an environment for the execution of at least some of the computer code involved in performing the inventive methods, such as a grounding generative questions program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network and/or querying a database, such as database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

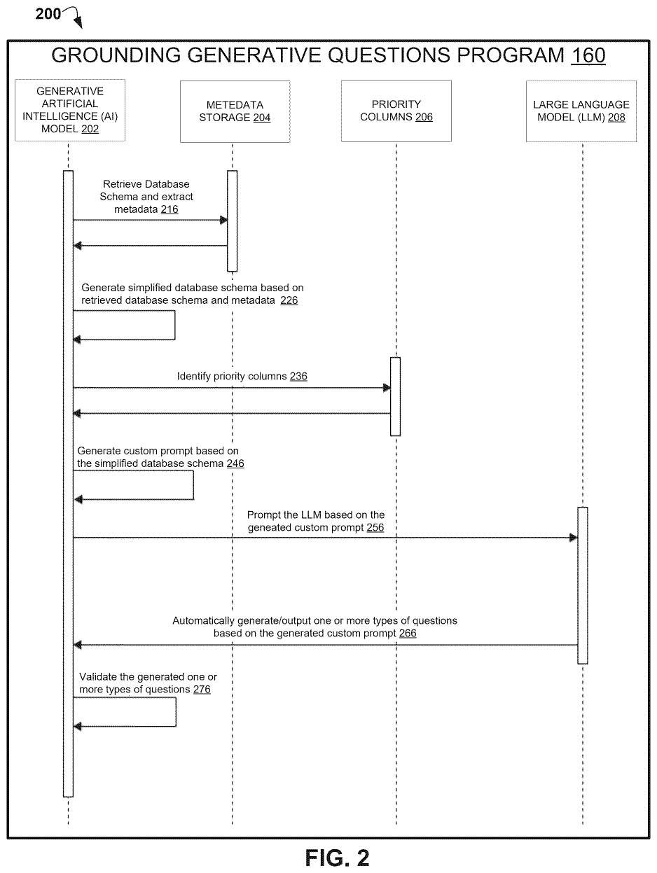

Furthermore, notwithstanding depiction in computer 101, the grounding generative questions program 160 may be stored in and/or executed by, individually or in any combination, with end user device 103, remote server 104, public cloud 105, and private cloud 106. The grounding generative questions program is explained in further detail below with respect to FIGS. 2-4.

According to the present embodiment, and as previously described, the grounding generative questions program 160 may be a program/code capable of retrieving a database schema by extracting metadata associated with at least one database. The grounding generative questions program 160 may further, based on the extracted metadata, automatically generate, using a generative artificial intelligence (AI) agent/algorithm, a simplified database schema comprising simplified database schema objects. The grounding generative questions program 160 may also automatically generate, using the generative AI agent/algorithm, a custom prompt based on the simplified database schema, wherein automatically generating the custom prompt further comprises generating an instruction set prompting the LLM to generate one or more different types of questions based on the simplified database schema. The grounding generative questions program 160 may then automatically generate, using the LLM, the one or more different types of questions based on the generated custom prompt, wherein generating the one or more different types of questions further comprises using the LLM to generate for each question a structured query language (SQL) representation of a generated question and an identification of a question type associated with the generated question. The grounding generative questions program 160 may further automatically validate the generated one or more different types of questions using an SQL parser to parse the SQL representation of the generated question, wherein using an SQL parser to parse the SQL representation of the generated question further comprises extracting columns from the simplified database schema matching the SQL representation.

Referring now to FIG. 2, a block diagram illustrating an operational flowchart 200 of a program for automatically grounding generative questions generated from a large language model (LLM) to prevent hallucinations from the LLM is provided. According to one embodiment, and as depicted in FIG. 2, the grounding generative questions program 160 may include or be integrated with a metadata storage 204 and a large language model (LLM) 208. More specifically, the grounding generative questions program 160 may use the metadata storage 204 to store and extract metadata associated with a database schema from one or more databases associated with one or more different types of databases. The LLM 208 may include a generative artificial intelligence (AI) model. As depicted at 216, the grounding generative questions program 160 may receive and/or retrieve a database schema by extracting metadata which may be associated with a database from the one or more different types of databases. For example, the database and/or database schema may be associated with an industry such as Retail, Telecommunications, Finance, Healthcare, Manufacturing, Technology, Energy, Transportation, Insurance, E-Commerce, etc. Furthermore, for example, the metadata associated with the received database schema may include data that describes a structure, content, and/or context of the database. Essentially, the metadata may include data about data that may further include information such as: column and table names and types (including priority columns), relationships between tables, data constraints, indexes and views, access restrictions, authorship, version numbers, and time stamps.

Thereafter, and as depicted at 226, based on the extracted metadata associated with the retrieved database schema, the grounding generative questions program 160 may generate, using a generative artificial intelligence (AI) agent/algorithm 202, a simplified database schema comprising simplified database schema objects. As previously described, the LLM may include a generative artificial intelligence (AI) model. Accordingly, the generative AI agent/algorithm 202 may be responsible for generating questions which relies on the LLM 208. Generally, and according to one embodiment, the generative AI agent/algorithm 202 may include one or more machine learning algorithms capable of receiving input such as text, images, audio, video, and code and subsequently generate new content into any of those aforementioned modalities (i.e. text, images, audio, video, and/or code). Furthermore, machine learning as described herein may broadly refer to machine learning algorithms that may learn from data and provide output. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models.

In turn, and as previously described, using the generative AI agent/algorithm 202, the grounding generative questions program 160 may generate a simplified database schema based on the extracted metadata associated with the received database schema, whereby the simplified database schema may include simplified database schema objects representing the received database schema. Specifically, for example, the simplified database schema objects may comprise simplified JavaScript Object Notation (JSON) objects representing the retrieved/received database schema. Generally, JavaScript Object Notation, or JSON, is an open standard file format and data interchange format that uses human-readable text to store and transmit data objects consisting of name-value pairs and arrays. The grounding generative questions program 160 may further include SQL server built-in functions and operators to transform arrays of the JSON objects into a table format. Accordingly, the simplified database schema that includes the JSON objects may include a set of columns with each column having stored column information to further help/guide the LLM 208 to automatically identify an industry type of the received database schema when eventually generating questions. According to one embodiment, the included column information may include information such as column name, aggregation, data type and usage. The generated simplified database schema is further used as a ground truth for generating questions from the LLM 208.

According to one embodiment, and as depicted at 236, the grounding generative questions program 160 may further automatically identify and/or determine whether at least one priority column 206 exist based on the retrieved/received database schema. Based on the determination that a priority column 206 does exist, the grounding generative questions program 160 may generate a JSON object representing the priority column 206. Specifically, in response to receiving the database schema, the grounding generative questions program 160 may further check for priority columns based on the metadata, based on whether columns have been specified as priority in the received database schema, and/or based on whether columns have been specified by a user. According to one embodiment, a priority column may include a column in the received database schema that may be given priority for use by the LLM 208 to direct the LLM 208 to favor such priority columns when generating one or more questions, thereby generating a set of questions more relevant to the priority column. Therefore, the LLM may be directed to give preference to these priority columns as part of the process of generating the questions. Accordingly, and as previously described, when generating the simplified database schema, the grounding generative questions program 160 may further create a JSON object for representing a priority column. Furthermore, the JSON object may identify/represent other columns that have an influence on the priority column. More specifically, the JSON object that is generated for the priority column may identify the column as a priority and may further include an identification of column influencers, which may include other columns in the received database schema that have a direct influence on values in the priority column, whereby a change in a value of a column influencer column may effectuate a change in a value associated with the priority column. For example, the grounding generative questions program 160 may identify a priority column in the received database schema such as a “Revenue” column. Furthermore, other columns that may have an influence on values in the “Revenue” column may include columns such as a “Product Name” column and/or a “Location” column. Therefore, the grounding generative questions program 160 may generate a priority column JSON object for the “Revenue” column that identifies the “Revenue” column as a priority and identifies the “Product Name” column and the “Location” column as column influencers. Therefore, the LLM 208 may be directed to give preference to the “Revenue” column as part of the process of generating the questions while also giving secondary consideration to the “Product Name” column and the “Location” column.

In turn, at 246, the grounding generative questions program 160 may generate, using the generative AI agent/algorithm 202, a custom prompt based on the simplified database schema, wherein generating the custom prompt further includes generating an instruction set prompting the LLM 208 to generate one or more different types of questions based on the simplified database schema. According to one embodiment, the custom prompt may include a natural language instruction set for the LLM 208 to, for example: generate a set of 10 different questions based on the generated simplified database schema, and generate the questions according to different question types based on a specified list of question types. For example, the specified list of question types may be generically specified/provided and/or may be specified based on a particular industry. For example, the following question types can be specified/provided and may be generic enough to apply to multiple industries such that the questions can be answered through querying a database: “item list”, “aggregation by time or category”, “item list with categorical/time filter”, and “identify lowest highest.” Accordingly, the grounding generative questions program 160 may generate a custom prompt that includes the instruction set and the specified list of question types. Also, according to one embodiment, the grounding generative questions program 160 may be configured to generate a custom prompt based on the simplified database schema object alone (i.e. without the inclusion of any priority column), and/or based on the simplified database schema object with the priority column. According to one embodiment, the difference between a custom prompt based on the simplified database schema object alone and a custom prompt based on the simplified database schema object with the priority column objects may be based on a few-shot training examples that are used to train the LLM 208. More specifically, when training the LLM 208 to generate an output (to be described at step 266), different training datasets may be used, whereby a first training dataset may be based on a simplified database schema object alone to train the LLM 208 to output questions simply based on the simplified database schema, and a second training dataset may be based on the simplified database schema object with the priority column objects to train the LLM 208 to output questions based on the simplified database schema and that are more relevant to the priority columns. Thereafter, at 256, and based on the custom prompt, the grounding generative questions program 160 may prompt the LLM 208.

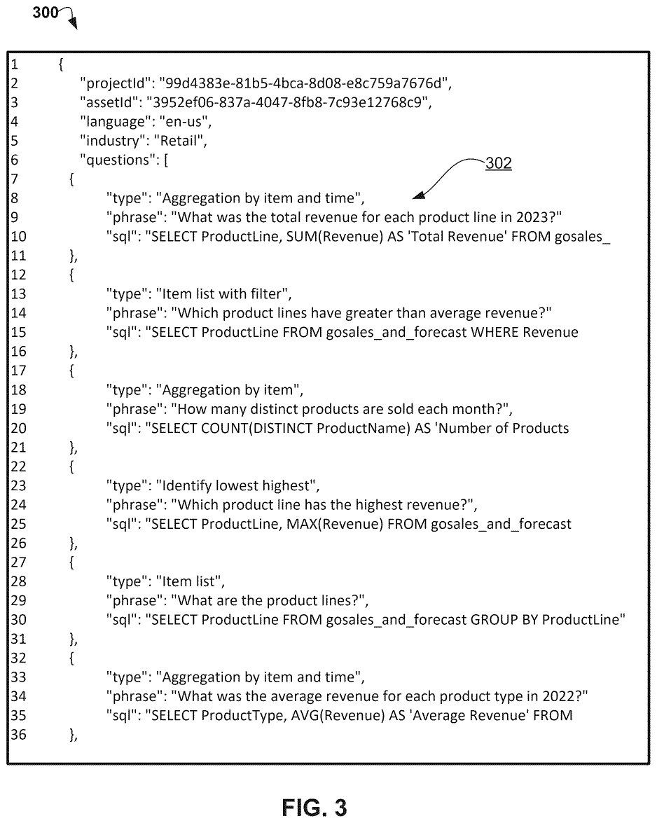

Next, at 266, the grounding generative questions program 160 may automatically generate, using the LLM 208, one or more types of questions based on the custom prompt, wherein generating the one or more types of questions further comprises using the LLM to generate for each question: 1) a natural language phrase/question, 2) a SQL representation of the natural language phrase/question (i.e. MySQL data query language representation of the question), and 3) an identification of a question type associated with the natural language phrase/question (which may include the LLM's 208 understanding of the type of question that the LLM 208 generated). According to one embodiment, the LLM 208 may be further prompted to identify the industry associated with the simplified database schema to further ensure that the generated one or more types of questions are relevant to the database schema. An example of a subset of output/results 300 (FIG. 3) from the LLM 208 (FIG. 2) based on the custom prompt is depicted in FIG. 3. For example, and as depicted at 302, one of the generated questions may include:
“type”: “Aggregation by item and time”,
“phrase”: “What was the total revenue for each product line in 2023?”
“sql”: “SELECT ProductLine, SUM (Revenue) AS ‘Total Revenue’ FROM gosales_”

As depicted above, the LLM may, for example, generate: 1) the natural language phrase/question—“What was the total revenue for each product line in 2023?”; 2) a SQL representation of the natural language phrase/question—“SELECT ProductLine, SUM (Revenue) AS ‘Total Revenue’ FROM gosales_”; and 3) an identification of the question type—“Aggregation by item and time”.

Then, at 276, the grounding generative questions program 160 may validate the generated one or more different types of questions to, for example, ensure that the LLM is not hallucinating. As previously described with respect to current problems with LLMs, LLM-based applications face a challenge in ensuring that the LLM does not hallucinate, i.e. when the LLM model generates a response that is false, nonsensical, or inconsistent with the input prompt, and/or when the LLM creates columns or filters that do not exist in the database schema. Therefore, in order to avoid such a case, the grounding generative questions program 160 may use the generated SQL for each question and the simplified database schema and objects to validate the generated one or more types of questions. Specifically, the grounding generative questions program 160 may include and use an SQL parser to parse the SQL representation of a generated question and, in turn, extract columns from the simplified database schema that matches the SQL representation. In other words, the SQL representations are directly checked against the simplified database schema and objects. If the column is not found in the simplified database schema, then the grounding generative questions program 160 may discard the generated question from being a valid question and use the discarding of the generated question based on a failure to identify the column associated with the SQL representation as training material for training the LLM.

Furthermore, according to one embodiment, the LLM 208 may be further prompted to identify the industry associated with the simplified database schema as a further validation tool. Specifically, and referring back to step 266, using the generated custom prompt and the simplified database schema, the grounding generative questions program 160 may prompt the LLM 208 to detect the industry of the simplified database schema, which may be used as a further technique to validate the LLM's understanding of the simplified database schema. In turn, the LLM 208 can respond with an identification of the specific industry (for example, and as previously described: Retail, Telecommunications, Finance, Healthcare, Manufacturing, Technology, Energy, Transportation, Insurance, E-Commerce), which may provide an indication that the LLM is able to understand the schema and hence the generated questions may be more relevant to the schema. According to one embodiment, in response to the LLM's failure to identify the industry (such as responding with “Unknown”), the grounding generative questions program 160 may be configured to discard the generated questions from being valid questions and use the discarding of the generated questions based on the LLM's failure to identify the industry as training material for training the LLM.

It may be appreciated that FIGS. 1-3 provide only illustrations of one implementation and does not imply any limitations with regard to how different embodiments may be implemented. Many modifications to the depicted environments may be made based on design and implementation requirements.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, and as previously described, machine learning as described herein may broadly refer to machine learning algorithms that may learn from data and provide output. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

What is claimed is:

1. A computer-implemented method for automatically grounding generative questions generated from a large language model (LLM) to prevent hallucinations from the LLM, the computer-implemented method comprising:
retrieving a database schema by extracting metadata associated with at least one database;
based on the extracted metadata, automatically generating, using a generative artificial intelligence (AI) algorithm, a simplified database schema comprising simplified database schema objects;
automatically generating, using the generative AI algorithm, a custom prompt based on the simplified database schema, wherein automatically generating the custom prompt further comprises generating an instruction set prompting the LLM to generate one or more different types of questions based on the simplified database schema;
automatically generating, using the LLM, the one or more different types of questions based on the generated custom prompt, wherein generating the one or more different types of questions further comprises using the LLM to generate for each question a structured query language (SQL) representation of a generated question and an identification of a question type associated with the generated question; and
automatically validating the generated one or more different types of questions using an SQL parser to parse the SQL representation of the generated question, wherein using an SQL parser to parse the SQL representation of the generated question further comprises extracting columns from the simplified database schema matching the SQL representation.

2. The computer-implemented method of claim 1, wherein automatically generating, using the generative AI algorithm, the simplified database schema comprising the simplified database schema objects further comprises:
generating, using the generative AI algorithm, JavaScript Object Notation (JSON) objects representing the retrieved database schema.

3. The computer-implemented method of claim 1, further comprising:
automatically identifying at least one priority column based on the retrieved database schema; and
based on the identified at least one priority column, generating, using the generative AI algorithm, a JSON object representing the identified at least one priority column and other columns influencing the identified at least one priority column.

4. The computer-implemented method of claim 3, further comprising:
training the LLM to generate the one or more different types of questions based only on the simplified database schema and based on a combination of the simplified database schema and the identified at least one priority column.

5. The computer-implemented method of claim 1, further comprising:
prompting the LLM to identify an industry associated with the generated one or more different types of questions based on the simplified database schema.

6. The computer-implemented method of claim 1, further comprising:
discarding the generated question from being a valid question based on a failure to identify a column associated with the SQL representation of the generated question; and
using the discarding of the generated question based on the failure to identify the column associated with the SQL representation as training material for training the LLM.

7. The computer-implemented method of claim 5, further comprising:
discarding the generated one or more different types of questions from being valid questions based on a failure from the LLM to identify the industry associated with the generated one or more different types of questions; and
using the discarding of the generated one or more different types of questions based on the failure from the LLM to identify the industry as training material for training the LLM.

8. A computer system for automatically grounding generative questions generated from a large language model (LLM) to prevent hallucinations from the LLM, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing operational steps comprising:
retrieving a database schema by extracting metadata associated with at least one database;
based on the extracted metadata, automatically generating, using a generative artificial intelligence (AI) algorithm, a simplified database schema comprising simplified database schema objects;
automatically generating, using the generative AI algorithm, a custom prompt based on the simplified database schema, wherein automatically generating the custom prompt further comprises generating an instruction set prompting the LLM to generate one or more different types of questions based on the simplified database schema;
automatically generating, using the LLM, the one or more different types of questions based on the generated custom prompt, wherein generating the one or more different types of questions further comprises using the LLM to generate for each question a structured query language (SQL) representation of a generated question and an identification of a question type associated with the generated question; and
automatically validating the generated one or more different types of questions using an SQL parser to parse the SQL representation of the generated question, wherein using an SQL parser to parse the SQL representation of the generated question further comprises extracting columns from the simplified database schema matching the SQL representation.

9. The computer system of claim 8, wherein automatically generating, using the generative AI algorithm, the simplified database schema comprising the simplified database schema objects further comprises:
generating, using the generative AI algorithm, JavaScript Object Notation (JSON) objects representing the retrieved database schema.

10. The computer system of claim 9, further comprising:
automatically identifying at least one priority column based on the retrieved database schema; and
based on the identified at least one priority column, generating, using the generative AI algorithm, a JSON object representing the identified at least one priority column and other columns influencing the identified at least one priority column.

11. The computer system of claim 10, further comprising:
training the LLM to generate the one or more different types of questions based only on the simplified database schema and based on a combination of the simplified database schema and the identified at least one priority column.

12. The computer system of claim 8, further comprising:
prompting the LLM to identify an industry associated with the generated one or more different types of questions based on the simplified database schema.

13. The computer system of claim 8, further comprising:
discarding the generated question from being a valid question based on a failure to identify a column associated with the SQL representation of the generated question; and
using the discarding of the generated question based on the failure to identify the column associated with the SQL representation as training material for training the LLM.

14. The computer system of claim 12, further comprising:
discarding the generated one or more different types of questions from being valid questions based on a failure from the LLM to identify the industry associated with the generated one or more different types of questions; and
using the discarding of the generated one or more different types of questions based on the failure from the LLM to identify the industry as training material for training the LLM.

15. A computer program product for automatically grounding generative questions generated from a large language model (LLM) to prevent hallucinations from the LLM, comprising:
one or more tangible computer-readable storage devices and program instructions stored on at least one of the one or more tangible computer-readable storage devices, the program instructions executable by a processor, the program instructions comprising:
retrieving a database schema by extracting metadata associated with at least one database;
based on the extracted metadata, automatically generating, using a generative artificial intelligence (AI) algorithm, a simplified database schema comprising simplified database schema objects;
automatically generating, using the generative AI algorithm, a custom prompt based on the simplified database schema, wherein automatically generating the custom prompt further comprises generating an instruction set prompting the LLM to generate one or more different types of questions based on the simplified database schema;
automatically generating, using the LLM, the one or more different types of questions based on the generated custom prompt, wherein generating the one or more different types of questions further comprises using the LLM to generate for each question a structured query language (SQL) representation of a generated question and an identification of a question type associated with the generated question; and
automatically validating the generated one or more different types of questions using an SQL parser to parse the SQL representation of the generated question, wherein using an SQL parser to parse the SQL representation of the generated question further comprises extracting columns from the simplified database schema matching the SQL representation.

16. The computer program product of claim 15, wherein automatically generating, using the generative AI algorithm, the simplified database schema comprising the simplified database schema objects further comprises:
generating, using the generative AI algorithm, JavaScript Object Notation (JSON) objects representing the retrieved database schema.

17. The computer program product of claim 16, further comprising:
automatically identifying at least one priority column based on the retrieved database schema; and
based on the identified at least one priority column, generating, using the generative AI algorithm, a JSON object representing the identified at least one priority column and other columns influencing the identified at least one priority column.

18. The computer program product of claim 15, further comprising:
prompting the LLM to identify an industry associated with the generated one or more different types of questions based on the simplified database schema.

19. The computer program product of claim 15, further comprising:
discarding the generated question from being a valid question based on a failure to identify a column associated with the SQL representation of the generated question; and
using the discarding of the generated question based on the failure to identify the column associated with the SQL representation as training material for training the LLM.

20. The computer program product of claim 18, further comprising:
discarding the generated one or more different types of questions from being valid questions based on a failure from the LLM to identify the industry associated with the generated one or more different types of questions; and
using the discarding of the generated one or more different types of questions based on the failure from the LLM to identify the industry as training material for training the LLM.
